(19) United States
(12) Patent Application Publication
(10) Pub. No.: US 2008/0016089 A1
(43) Pub. Date: Jan. 17, 2008

(54) Recording/reproducing apparatus

(76) Inventor: Mika Nishiyama, Yokohama (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/506,784

(22) Filed: Aug. 21, 2006

(30) Foreign Application Priority Data
Nov. 18, 2005 (JP) 2005-333563

(51) Int. Cl. G06F 7/00

(52) U.S. Cl. 707/100

(57) ABSTRACT

Chapters exhibiting different attributes can be delimited. Among the delimited chapters, chapters exhibiting a designated specific attribute are distinguished. For this purpose, for example, program data is recorded, and chapters exhibiting different attributes are sampled from the recorded program data. An indicator field indicating to which temporal positions in the recorded program data the plurality of sampled chapter data items correspond is displayed. A desired attribute is selected from among the plurality of attributes. When the indicator field is displayed, control is extended so that the indicator field will indicate to which temporal positions in the recorded program data chapter data items, which exhibit the selected attribute, correspond.

### BACKGROUND OF THE INVENTION

1. Field of the Invention

The present invention relates to a recording/reproducing apparatus that records or reproduces a motion picture.

2. Description of the Related Art

In commercial broadcasting, normally, a commercial message (hereinafter a CM) is inserted into a program. A border between a CM and the contents of a program (hereinafter referred to as a story portion) is detected during picture recording, and the story portion and CM are delimited by the border. Temporally delimited parts of a program are recorded as respective chapters. This kind of technology is described in, for example, Patent Documents 1 and 2 (refer to Japanese Unexamined Patent Publications Nos. 2005-64914 and 2005-142853).

In particular, Japanese Unexamined Patent Publication No. 2005-142853 has disclosed that among thumbnails representing respective chapters that are time-sequentially arranged, thumbnails of chapters exhibiting the selected attribute are, as shown in FIG. 3 and FIG. 10 therein, provided with a colored frame or mark and thus distinguished.

Moreover, Japanese Unexamined Patent Publication No. 2004-140675 describes a technology for detecting an exciting scene contained in a program (hereinafter referred to as a highlight) on the basis of a change in audio data of background music (BGM), and delimiting it as one chapter.

### SUMMARY OF THE INVENTION

In the recording/reproducing apparatuses disclosed in the above Japanese Patent Publications, when a program is recorded or when a recorded program is edited, a plurality of program portions exhibiting one of features (hereinafter, attributes) of video or audio data representing a program is sampled and delimited. Thus, a program is divided into a plurality of portions. In general, the delimited portions are referred to as chapters. One program portion exhibiting the attribute is regarded as a chapter. For example, in Patent Documents 1 and 2, CMs are detected, and a program is segmented into chapters of story portions and chapters of CMs with each CM regarded as a border between story portions.

The above Patent Documents have disclosed that: an attribute is used to segment a program into a plurality of chapters; and the plurality of chapters exhibiting the attribute is skipped during reproduction or editing or the plurality of chapters exhibiting the attribute is reproduced or edited. However, the disclosed technologies suffer poor maneuverability.

For example, when chapters of recorded video or audio date are displayed, if a way of displaying chapters is varied depending on each attribute, which attributes chapters exhibit are recognized. However, since a large number of display forms is used to present a plurality of attributes, it cannot help but give a sense of congestion.

Any of the Patent Documents has not referred to processing to be performed when a user designates a specific attribute among a plurality of attributes with which chapters are delimited. A method of displaying chapters exhibiting the designated attribute has not been disclosed in practice.

Moreover, for a display screen that is limited in the same manner as the one of a portable cellular phone, there is a need for a simple display form.

Consequently, in order to improve user friendliness, consideration should be taken into more concrete use situations.

Accordingly, an object of the present invention is to provide a user-friendly recording/reproducing apparatus.

In order to solve the aforesaid problems, for example, chapters exhibiting different attributes are delimited, chapters exhibiting a user-designated attribute are sampled from among the delimited chapters, and to which temporal positions in an entire program the chapters correspond are specified.

To be more specific, for example, according to the first aspect of the present invention, a recording/reproducing apparatus includes: a program recording unit that records program data; a sampling unit that samples chapter data items exhibiting different attributes from the program data recorded by the program recording unit; a display unit that displays an indicator field indicating to which temporal positions in the program data the chapter data items sampled by the sampling unit correspond; an attribute selection unit that selects one attribute from among the plurality of attributes; and a control unit that, when the indicator field is displayed on the display unit, extends control so that the indicator field will indicate to which temporal positions in the recorded program data the chapter data items exhibiting the attribute selected by the attribute selection unit correspond.

Owing to the above components; a user-can select a desired attribute and will find the display screen image easy to see. Thus, a user-friendly recording/reproducing apparatus is provided.

To which positions in an entire program the chapter data items exhibiting not only a desired attribute but also the other attributes correspond may have to be indicated. For example, assuming that attributes include an attribute CM and an attribute Highlight as they do in embodiments to be described later, to which positions in a program CM scenes and highlight scenes correspond may have to be grasped. In this case, assuming that either of a display image associated with a user's desired attribute and a display image associated with all the attributes may be able to be selected, if a user feels that one display image may become hard to see, the user can change the display image to the other. Consequently, user-friendliness further improves. In the embodiments, attributes shall include the attribute CM and the attribute Highlight. However, the present invention is not limited to the attributes.

For example, attributes may be set to those permitting a user to designate a scene in a program where the user's favorite entertainer or a predetermined entertainer appears or a scene in a music program where a talk show evolves or a singer sings.

As a chapter sampling method, a scene turning point sampling method in which if an inner product or Euclidean norm worked out using adjoining image data items exceeds a predetermined value, one scene is regarded to be changed to another or a method of sampling a maximum volume point and its neighborhood may be adopted. The present invention is not limited to the embodiments.

Attributes may be sampled or detected from recorded program data. Otherwise, an acquisition unit may be included for, for example, acquiring attributes together with program data over the Internet or acquiring attributes independently. If attributes can be acquired independently, it provides the merit that a step of sampling attributes can be omitted.

If an indicator indicating the temporal progress of reproduction and a desired attribute can be selected through the same screen image, a user need not change display screen images by performing manipulations. Namely, after a user selects a desired attribute, the user can grasp, through the same screen image, with which parts of the indicator chapter data items exhibiting the attribute are associated. The user will find it user-friendly.

Moreover, the indication of the indicator may be varied depending on a user's desired attribute. Anyhow, parts of the indicator with which chapter data items exhibiting the attribute are associated may be highlighted, for example, displayed in red or any other strong color otherwise, the shape of the parts may be enlarged, contracted, or deformed. If the presences of respective chapter data items exhibiting an attribute can be distinguished, a user can intuitively recognize which parts of the indicator are associated with the chapter data items. The user-friendliness further improves.

In the embodiments to be described later, the indicator shall be shaped like a bar. The present invention is not limited to this shape. Alternatively, an indicator graduated with character strings representing time instants or a circular indicator or a hexagonal or polygonal indicator may be used to present information to a user.

Moreover, the indicator may include a predetermined cursor so that a user can freely change a position in a program, where is reproduced, by manipulating keys. In this case, as soon as a desired attribute is selected, chapter data items exhibiting the desired attribute may be reproduced. This further improves user-friendliness.

According to the present invention, a user-friendly recording/reproducing apparatus can be provided.

### BRIEF DESCRIPTION OF THE DRAWINGS

FIG. 1 is a block diagram of a recording/reproducing apparatus in accordance with the first embodiment;

FIG. 2 shows management information recorded according to the first embodiment to have motion picture data associated with reproduction control information;

FIG. 3 illustratively shows the structure of motion picture data to be recorded under one title in a hard disk drive (HDD) included in the first embodiment;

FIG. 4 shows the structure of reproduction control information employed in the first embodiment;

FIG. 5 shows a title list display screen image listing titles of motion picture data items recorded in the HDD included in the first embodiment;

FIG. 6 shows a partial deletion operating screen image relevant to an attribute CM employed in the first embodiment;

FIG. 7 shows a partial deletion operating screen image relevant to an attribute Highlight employed in the first embodiment;

FIG. 8 shows a partial deletion operating screen image relevant to both the attributes employed in the first embodiment;

FIG. 9 shows a screen image appearing after partial deletion is designated according to the first embodiment;

FIG. 10 shows the layout of major keys of a remote controller included in an operating input unit included in the first embodiment;

FIG. 11 is a flowchart describing a procedure started with display of the title list display screen image shown in FIG. 5 and ended with display of the partial deletion operating screen image shown in FIG. 6;

FIG. 12 is a flowchart describing switching of chapter attributes and execution of partial deletion;

FIG. 13 is a block diagram of a recording/reproducing apparatus in accordance with the second embodiment;

FIG. 14 shows a title list display screen image listing titles of motion picture data items recorded in an HDD included in the second embodiment;

FIG. 15 shows a scene change detection attribute designation menu display screen image employed in the second embodiment;

FIG. 16 shows a display screen image appearing during scene change detection according to the second embodiment;

FIG. 17 shows a display screen image appearing with completion of scene change detection according to the second embodiment; and

FIG. 18 is a flowchart describing a procedure of scene change detection employed in the first embodiment.

### DESCRIPTION OF THE PREFERRED EMBODIMENTS

Referring to the drawings, embodiments of the present invention will be described below. In the drawings, the same reference numerals are assigned to components sharing the same capabilities, and an iterative description will be omitted. Moreover, recording (picture recording) shall refer to recording (picture recording) of a commercial broadcasting program received via a tuner. The present invention is not limited to this mode but may be applied to a mode in which video signal received from an externally input device that is not shown is recorded (recorded as video data).

### First Embodiment

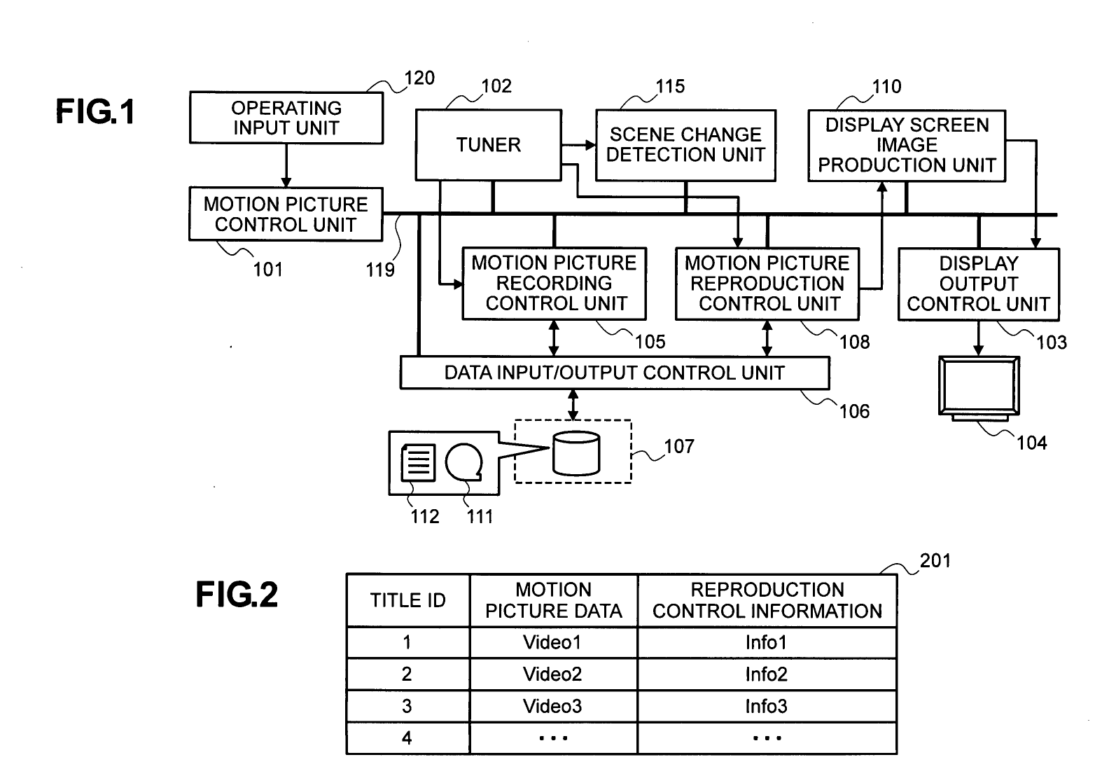

FIG. 1 is a block diagram of a recording/reproducing apparatus in accordance with the first embodiment. The recording/reproducing apparatus in accordance with the present embodiment can be adapted to an HDD/DVD recorder, a television with a recording facility in which the HDD/DVD recorder is incorporated, a portable terminal such as a portable cellular phone, and a personal computer (PC).

In FIG. 1, a motion picture control unit 101 is an arithmetic control device including a central processing unit. The motion picture control unit 101 receives a manipulative input entered by a user at an operating input unit 120, uses an incorporated random access memory (RAM), which is not shown, as a work area to, if necessary, control the components of a recording/reproducing apparatus over a bus 119 according to a program written in an incorporated ROM (not shown). The motion picture control unit 101 thus performs predetermined processing.

For example, the motion picture control unit 101 transmits a motion picture of a desired program, which is distributed through commercial broadcasting (television, satellite broadcasting, or commercial satellite broadcasting) and received by a tuber 102 serving as a broadcasting reception control means, to a display device 104 via a display output control unit 103.

Moreover, the motion picture control unit 101 controls a motion picture recording control unit 105 and a motion picture reproduction control unit 108, which will be described later, to record or reproduce a motion picture. Moreover, the motion picture control unit 101 produces management information (which will be detailed later) concerning motion picture data according to scene changes detected by a scene change detection unit 115 that will be described later. Incidentally, an external display may be adopted as the display device 104.

The motion picture recording control unit 105 records motion picture data, which is a broadcasting program received by the tuner 102, in a data recording/reproducing means 107 via a data input/output control unit 106 under the control of the motion picture control unit 101. At this time, the motion picture recording control unit 105, if necessary, compresses (for example, according to the MPEG standards) or encodes the motion picture data. Moreover, the motion picture recording control unit 105 changes formats so that the motion picture data will match a recording format supported by the data recording/reproducing means 107. Moreover, the motion picture recording control unit 105 returns information on a currently recorded position in response to a query issued from the motion picture control unit 101. Moreover, the motion picture recording control unit 105 receives management information, which will be described later, from the motion picture control unit 101 and records it in the data recording/reproducing means 107.

The data input/output control unit 106 introduces motion picture data received from the motion picture recording control unit 105 and management information to be described later into the data recording/reproducing means 107 while buffering them in an incorporated memory, which is not shown, under the control of the motion picture control unit 101. Moreover, the data input/output control unit 106 introduces motion picture data read from the data recording/reproducing means 107 and management information to be described later to the motion picture reproduction control unit 108 while buffering them.

The data recording/reproducing means 107 that records or reproduces motion picture data and management information to be described later includes, in the present embodiment, a hard disk drive (hereinafter HDD) using a hard disk as a recording medium and an HDD controller (not shown). For convenience's sake, the data recording/reproducing means 107 shall be referred to as an HDD unit.

However, the present invention is not limited to the above configuration of the data recording/reproducing means. Alternatively, the data recording/reproducing means may include an optical drive, which adopts an optical disk (CD-R, CD-RW, DVD-RAM, DVD±R, DVD±RW, etc.) as a recording medium, and an optical drive controller.

In the HDD unit 107, motion picture data 111 and reproduction control information 112 concerning the motion picture data 111 are recorded in association with each other as management information.

FIG. 2 shows an example of management information recorded according to the present embodiment to have the motion picture data 111 associated with the reproduction control information 112 (which will be detailed later). As shown in FIG. 2, the motion picture control unit 101 assigns a title identifier (ID), which is determined for each recording unit, for example, a title, to the motion picture data 111 and the reproduction control information 112 associated with the motion picture data 111, manages them as management information 201, and records the management information in the HDD unit 107 via the motion picture recording control unit 105.

In the HDD unit 107, the motion picture data 111 and reproduction control information 112 may be recorded in a file created relative to one title. Alternatively, data items and pieces of information relevant to all titles may be recorded in one file.

When all data items and pieces of information are recorded in one file, if the start and end positions relevant to each title in the file are recorded, the data and information relevant to the title can be readily accessed. Herein, as shown in FIG. 2, one file is created relative to each title.

The motion picture reproduction control unit 108 reads the motion picture data 111 and reproduction control information, which are recorded in the HDD unit 107, via the data input/output control unit 106 under the control of the motion picture control unit 101, and reproduces a motion picture. The motion picture reproduction control unit 108 decodes the motion picture data 111 supposing the motion picture data 11 has been encoded (for example, compressed according to the MPEG standards).

When a motion picture is reproduced based on the data recorded in the HDD unit 107, the motion picture reproduced by the motion picture reproduction control unit 108 is substituted for a broadcasting program received by the tuner 102, and transmitted to the display output control unit 103 via a display screen image production unit 110 so that the motion picture will be displayed on the display unit 104.

The management information 201 is transmitted to the motion picture control unit 101 over the bus 119. Upon receipt of the management information 201, the motion picture control unit 101 samples the reproduction control information 112, which is concerned with the motion picture data having a currently selected title, from the management information 201, and transmits the reproduction control information 112 to the display screen image production unit 110. The display screen image production unit 110 in turn produces a predetermined graphic user interface (GUI) screen image, and displays the screen image on the display device 104 via the display output control unit 103.

The display screen image production unit 110 produces a graphic user interface (GUI) image such as a menu screen image under the control of the motion picture control unit 101. The motion picture control unit 101 transmits the GUI screen image, which is produced by the display screen image production unit 110, to the display device 104 via the display output control unit 103. The display screen image production unit 110 receives the motion picture, which is, if necessary, transferred from the motion picture reproduction control unit 108, and produces a GUI image.

Moreover, the operating input unit 120 includes an infrared remote controller (hereinafter a remote controller) which is not shown and via which user's manipulations are received, an infrared receiver (not shown) that receives an infrared signal from the remote controller and converts it into an electric signal, and operation buttons (not shown) formed on the face of the housing of the recording/reproducing apparatus. The operating input unit 120 receives user's manipulations. A user's manipulative input is transmitted to the motion picture control unit 101. The motion picture control unit 101 performs predetermined processing according to the user's manipulative input.

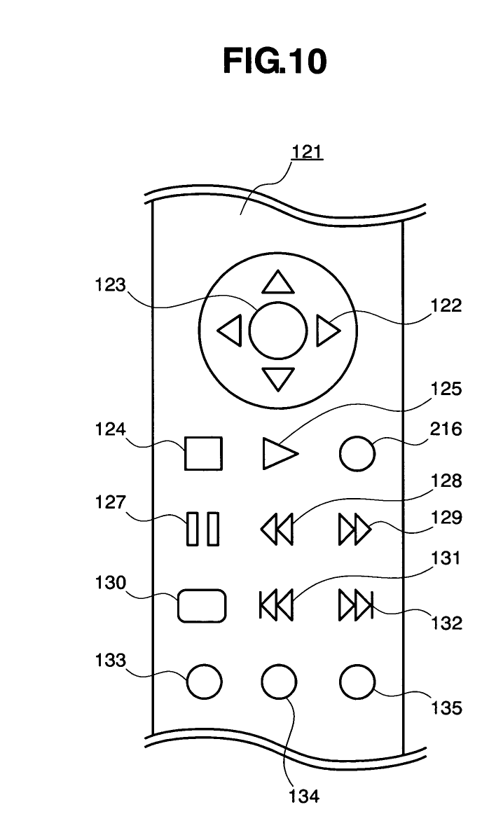

FIG. 10 shows the layout of major keys included in the remote controller included in the operating input unit 120, that is one of the components of the present embodiment. Referring to FIG. 10, direction buttons 122 for use in moving a cursor upward, downward, rightward, or leftward in a GUI screen image, a decision button 123 for use deciding a cursor position designated using the direction buttons 122, a menu button 130 for use in displaying a menu screen image, an attribute CM button 133 for use in selecting an attribute CM that will be described later, an attribute Highlight button 134 for use in selecting an attribute Highlight to be described later, and a both-attributes button 135 for use in selecting both the attribute CM and attribute Highlight are arranged on the remote controller 121.

Also arranged are a stop button 124 for use in designating stop of the HDD unit 107, a reproduction button 125 for use in designating reproduction, a recording button 126 for use in designating recording (picture recording), a pause button 127 for use in designating a pause, a quick return button 128 for use in designating a quick return, a quick advance button 129 for use in designating a quick advance, a skip button 131 for use in designating a skip in a returning direction, a skip button 132 for use in designating a skip in a forward direction. A power button that is not shown and used to designate turning on or off of the power supply is also disposed.

Referring back to FIG. 1, the scene change detection unit. 115 detects a scene change, that is, a change from or into a scene occurring in the motion picture data 111 under the control of the motion picture control unit 101 during recording (picture recording) of the motion picture data received from the tuner 102. The scene change detection unit 115 included in the present embodiment detects changes of or into scenes exhibiting different attributes.

Herein, the scene change detection unit 115 includes a facility (CM detecting facility) for detecting changes from scenes of CMs into to story portions or vice versa, and a facility (highlight detecting facility) for detecting highlight scenes, for example, as described in Patent Document 4.

When detecting a scene change, the scene change detection unit 115 transmits information on detection of the scene change and a detected attribute to the motion picture control unit 101 over the bus 119.

For example, when the CM detecting facility acts, an attribute CM is transmitted as an attribute detected in order to detect a scene change. When the highlight detecting facility acts, an attribute Highlight is transmitted as the attribute detected in order to detect a scene change.

The detecting facilities transmit information on a scene change when detecting initial and final scene changes. The motion picture control unit 101 in turn queries the motion picture recording control unit 105 about information on a currently recorded position. The information on a currently recorded position returned from the motion picture recording control unit 105 is regarded as information on a scene change position, that is, a position where one scene is changed to another.

Every time a scene change occurs, the reproduction control information 112 including information on a scene change position, an attribute, and a chapter number assigned to a chapter delimited with the scene change is temporarily stored in a RAM, which is not shown, in association with a title ID of a currently recorded motion picture.

When picture recording is completed, the motion picture control unit 101 transmits the title ID and reproduction control information, which are stored in the RAM, as management information to the motion picture recording control unit 105. The motion picture recording control unit 105 receives the management information and records it in the HDD unit 107.

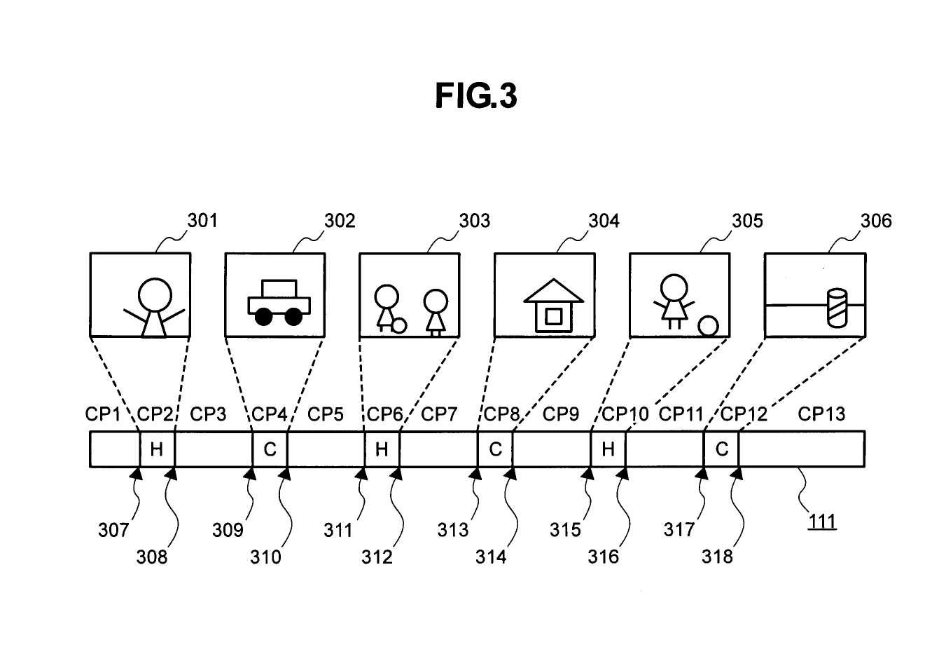

Next, the structure of motion picture data segmented by scene changes will be described in conjunction with FIG. 3.

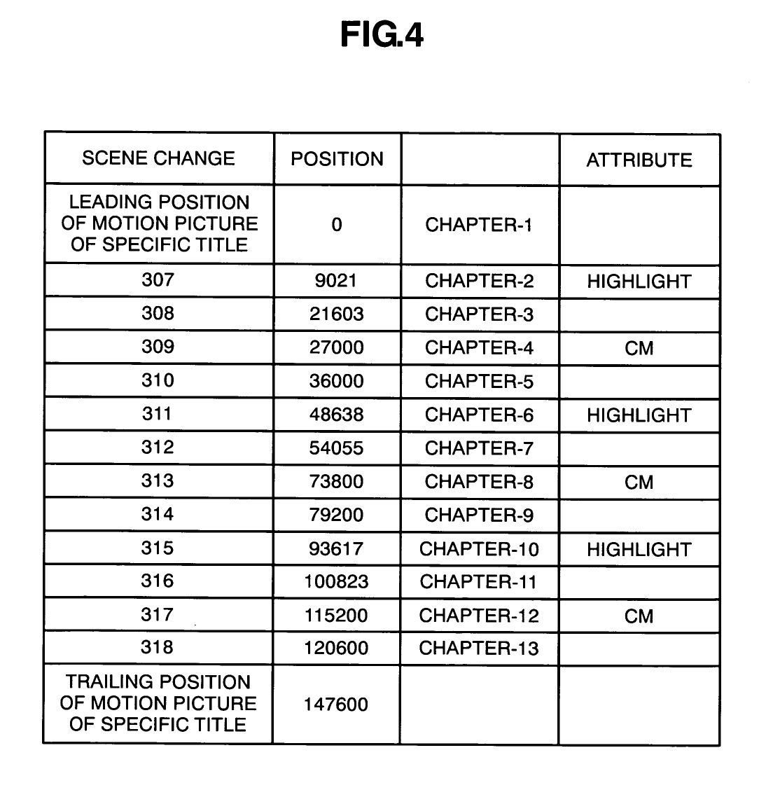

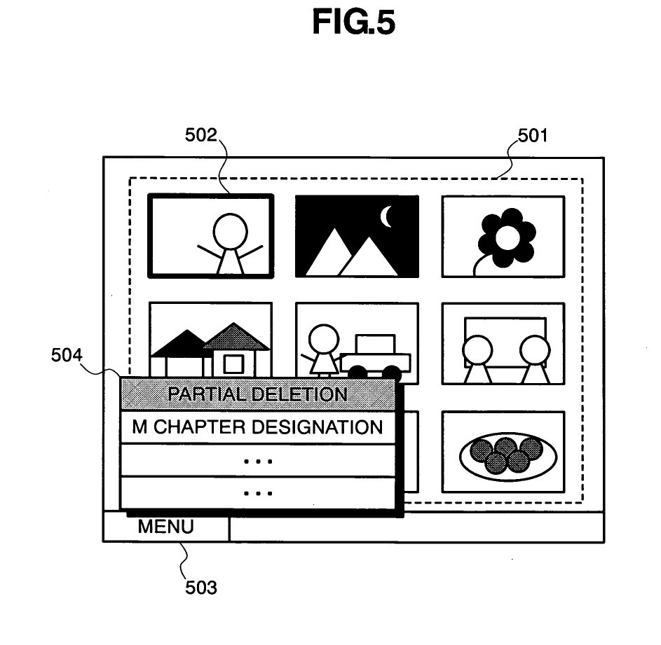

FIG. 3 illustratively shows the structure of the motion picture data 111 to be recorded under one title in the HDD unit 107. FIG. 4 shows an example of the reproduction control information 112.

Referring to FIG. 3, when the scene change detection unit 115 detects changes of or into scenes exhibiting predetermined attributes, scene change positions 307 to 318 are, as shown in FIG. 3, designated based on the scene changes. The scene change positions 307 to 318 are designated on the assumption that the left edge of the motion picture data 111 (leading address of title motion picture data) is regarded as a start of the motion picture data and the right edge thereof is regarded as an end point thereof. Every time a scene change occurs, a chapter is delimited.

To be more specific, when the motion picture data 111 is recorded in the HDD unit 107, every time the scene change detection unit 115 detects a scene change, the motion picture control unit 101 receives information on a recorded position from the motion picture recording control unit 105, and stores the information as a scene change position in the RAM that is not shown.

A scene change position that is a position where a scene is changed to another is detected by counting the number of recorded frames started with a leading frame. When recording of motion picture data is completed, the motion picture control unit 101 stores via the motion picture recording control unit 105 the received information on the scene change position as reproduction control information 112 concerning the recorded motion picture data in the HDD unit 107.

At this time, the motion picture control unit 101 manages as one chapter a range:from-one scene change position to the next scene change position.

For example, as shown in FIG. 3, when the scene change positions 307 to 318 are detected as shown in FIG. 3, the motion picture control unit 101 defines chapter CP1 at the leading position of the title motion picture data 111, defines a chapter, which succeeds a scene change occurring at the scene change position 307, as chapter CP2, and defines a chapter, which succeeds a scene change occurring at the next scene change position 308, as chapter CP3. Thus, the motion picture data is segmented with the scene change positions regarded as borders.

Specifically, a range from the leading position in the title motion picture data 111 to the scene change position 307 is defined as chapter CP1, and a range from the scene change position 307 to the scene change position 308 is defined as chapter CP2. Thus, chapters CP1 to CP13 are managed.

In FIG. 3, reference numerals 301, 302, 303, 304, 305, and 306 denote images representative of motion picture portions of respective chapters CP2, CP4, CP6, CP8, CP10, and CP12. For convenience sake, the entire motion picture portion of each chapter shall be referred to as a scene.

Information on each scene change includes, as shown in FIG. 4, information on a scene change position and an attribute detected by the scene change detection unit 115 (for example, the attribute CM or the attribute Highlight).

In association with a chapter succeeding a scene change which the scene change detection unit 115 has detected as a change to a scene of a CM, the motion picture control unit 101 specifies CM as the attribute of the chapter in the reproduction control information 112. For example, referring to FIG. 3, if the CM detecting facility included in the scene change detection unit 115 detects the scene change positions 309 and 310, that is, if the scene 302 between the scene change positions 309 and 310 is detected as a CM, CM is specified as the attribute of chapter CP4 between the scene change positions 309 and 310.

In FIG. 3, reference numeral C denotes the attribute CM. Likewise, if scenes 304 and 306 are detected as CMs respectively, CM is specified as the attributes of the chapters CP8 and CP12.

Moreover, in association with a chapter detected as a highlight by the scene change detection unit 115, the motion picture control unit 101 specifies Highlight as the attribute of the chapter in the reproduction control information 112.

For example, referring to FIG. 3, if the highlight detecting facility included in the scene change detection unit 115 detects the scene change positions 307 and 308, that is, if the scene 301 is detected as a highlight, Highlight is specified as the attribute of chapter CP2 between the scene change positions 307 and 308. In FIG. 3, reference numeral H denotes the attribute Highlight. Likewise, if the scenes 303 and 305 are detected as highlights respectively, Highlight is specified as the attributes of chapters CP6 and CP10.

As mentioned above, the reproduction control information 112 employed in the present embodiment includes at least, as shown in FIG. 4, information on a scene change position, information on a chapter delimited by adjoining scene change positions, and the attribute of the chapter. The other information included in the reproduction control information 112 is, for example, information on partial deletion that will be described later. A segment for which partial deletion is designated is skipped and will not be reproduced.

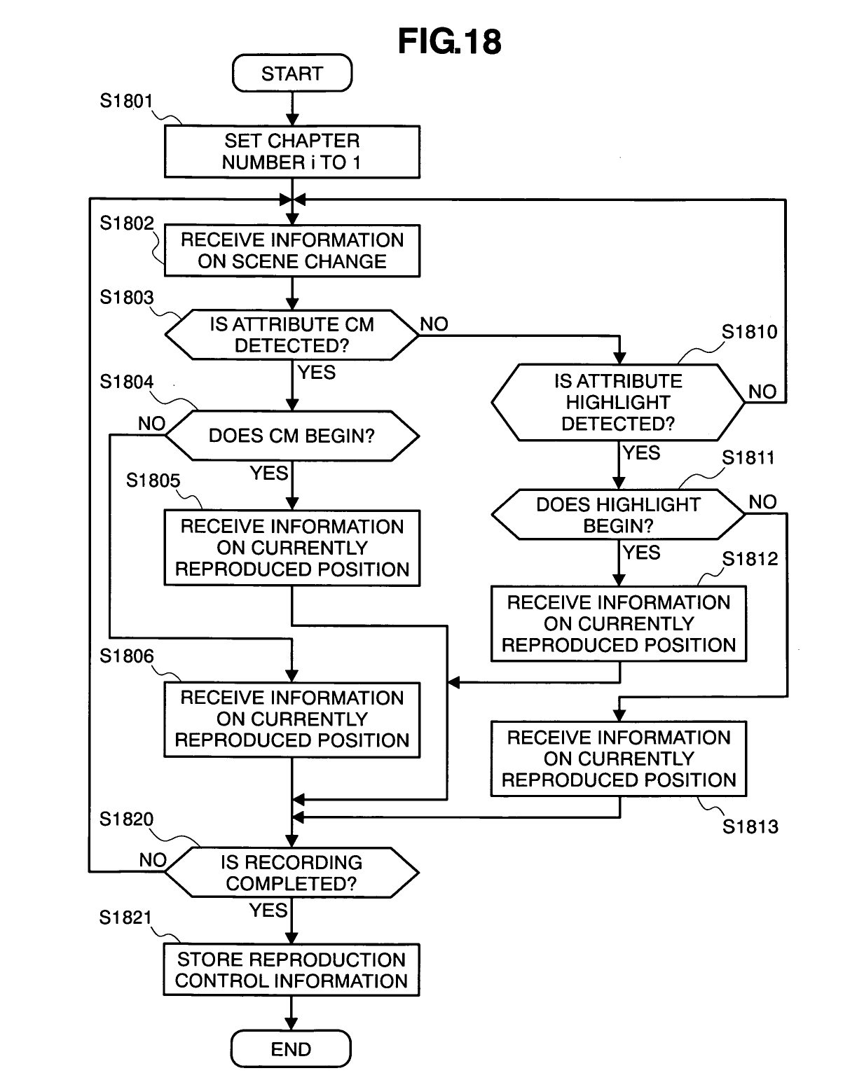

Next, scene change detection to be performed by the motion picture control unit 101 during picture recording will be described in conjunction with the flowchart of FIG. 18.

Assuming that recording of a TV program is designated with a user's manipulation, the motion picture control unit 101 instructs the motion picture recording control unit 105 to record the TV program in the HDD unit 107, and initiates scene change detection.

When picture recording is initiated, the motion picture control unit 101 appends a title ID to the program to be recorded at step 1801, sets a chapter number to 1, and stores the title ID in the RAM that is not shown and used as a work area. At step 1802, the motion picture control unit 101 receives information on a scene change and detected attribute from the scene change detection unit 115. At step 1803, the motion picture control unit 101 checks the attribute to see if it is the attribute CM. If the attribute is the attribute CM, the motion picture control unit 101 proceeds to step 1804 and decides whether a CM begins.

If the attribute CM is received for the first time, the beginning of a CM is recognized at step 1804. If the beginning of a CM is recognized at step 1804, information on a currently reproduced position is received from the motion picture recording control unit 105 at step 1805. A chapter number obtained by incrementing the current chapter number by 1 is assigned to a chapter succeeding the currently reproduced position. The currently reproduced position, changer number, and attribute are stored in the RAM, which is not shown, in association with one another. The motion picture control unit 101 proceeds to step 1820.

If the attribute CM is received for the second time at step 1804, it means that a scene change signifying the termination of a CM is detected. The motion picture control unit 101 recognizes the termination of the CM and proceeds to step 1806. At step 1806, the motion picture control unit 101 receives information on a currently reproduced position from the motion picture recording control unit 105. A chapter number obtained by incrementing the current chapter number by 1 is assigned to the chapter succeeding the currently reproduced position. The currently reproduced position and chapter number are: stored in the RAM, which is not shown, in association with each other. The motion picture control unit 101 proceeds to step 1820. Through steps 1804 to 1806, a segment defined by the beginning and termination of a CM is delimited as one chapter, and the attribute of the chapter is the attribute CM.

If the motion picture control unit 101 does not recognize the attribute as the attribute CM at step 1803, it proceeds to step 1810 and checks the attribute to see if it is the attribute Highlight. If the motion picture control unit 101 recognizes the attribute as the attribute Highlight, it proceeds to step 1811 and decides whether a highlight begins.

If the attribute Highlight is received for the first time at step 1811, the beginning of a highlight is recognized. If the beginning of a highlight is recognized at step 1811, information on a currently reproduced position is received from the motion picture recording control unit 105 at step 1812. A chapter number obtained by incrementing the current chapter number by 1 is assigned to the chapter succeeding the currently reproduced position. The currently reproduced position, chapter number, and attribute are stored in the RAM, which is not shown, in association with one another. The motion picture control unit 101 proceeds to step 1820.

If the attribute Highlight is received for the second time at step 1811, it means that a scene change signifying the termination of a highlight is detected. The motion picture control unit 101 recognizes the termination of a highlight and proceeds to step 1813. At step 1813, information on a currently reproduced position is received from the motion picture recording control unit 105.

A chapter number obtained by incrementing the current chapter number by 1 is assigned to the chapter succeeding the currently reproduced position. The currently reproduced position and chapter number are stored in the RAM, which is not shown, in association with each other. The motion picture control unit 101 then proceeds to step 1820. Through steps 1811 to 1813, a segment defined with the beginning and termination of a highlight is delimited as one chapter, and the attribute of the chapter is specified as the attribute Highlight.

At step 1820, the motion picture control unit 101 decides whether program (picture) recording is completed. If the motion picture control unit 101 makes a decision in the negative (No), it returns to step 1802 and proceeds with processing. If the motion picture control unit 101 makes a decision in the affirmative (Yes), it proceeds to step 1821. At step 1821, the motion picture control unit 101 instructs the motion picture recording control unit 105 to store in the HDD unit 107 the scene change position, the chapter number of the chapter preceding or succeeding the scene change position and the attribute of the chapter preceding or succeeding the scene change position, which are stored in the RAM that is not shown, as reproduction control information concerning the assigned title ID.

As mentioned above, the reproduction control information like the one shown in FIG. 4 is produced.

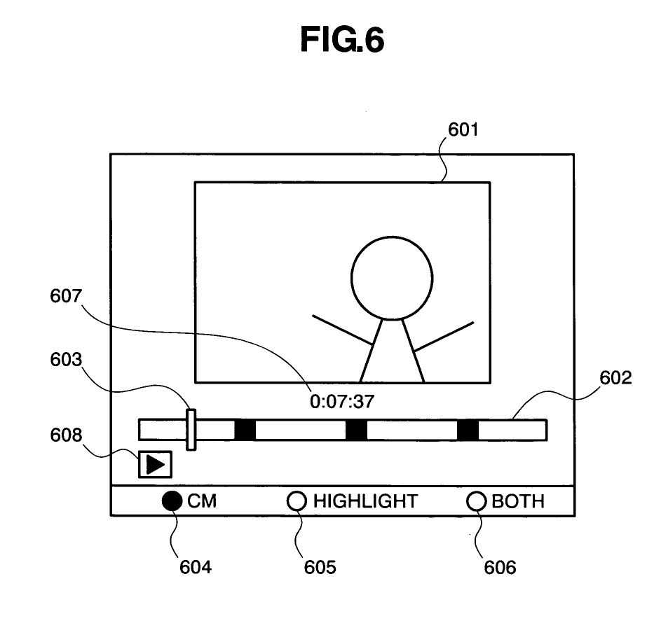

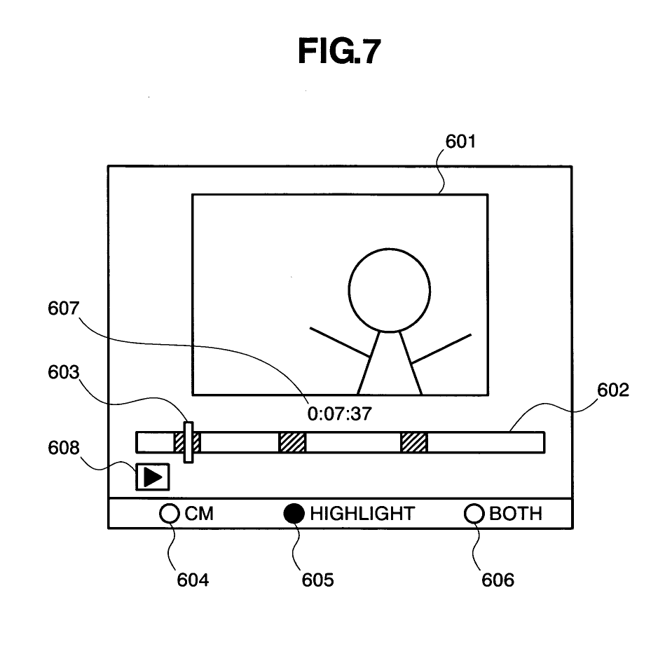

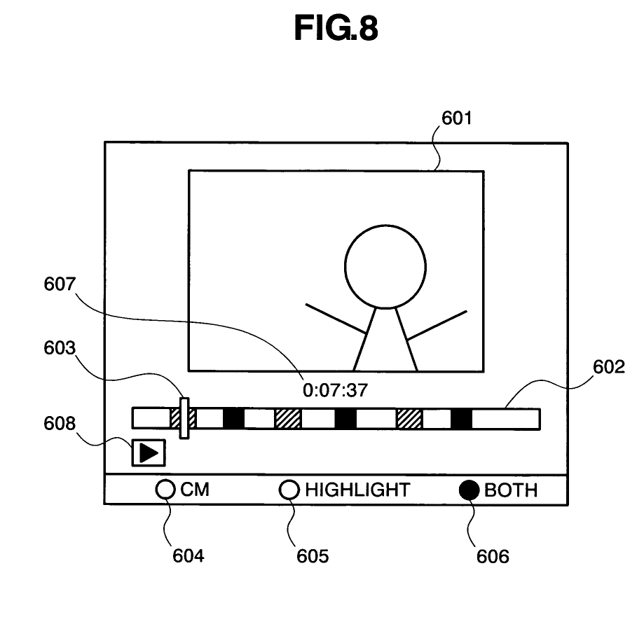

Referring to FIG. 5 to FIG. 8, a description will be made of a display screen image displayed by the recording/reproducing apparatus in accordance with the present embodiment. FIG. 5 shows a title list display screen image showing a list of titles assigned to motion picture data items recorded in the HDD unit included in the present embodiment. FIG. 6 shows an operating screen image to be displayed in the present embodiment in a case where Partial Deletion is selected from a menu representation. FIG. 7 and FIG. 8 show operating screen images to be displayed in a case where the other chapter attribute is selected through the screen image shown in FIG. 6. The screen images shown in FIG. 5 to FIG. 8 are produced by the display screen image production unit 110 and displayed on the display device 104 via the display output control unit 103.

To begin with, a description will be made in conjunction with FIG. 5. Referring to FIG. 5, when a plurality of titles of motion pictures recorded in the HDD unit 107 is displayed in the form of a list, the motion picture control unit 101 displays thumbnails, which are still images showing respective scenes suggestive of the respective titles, on the thumbnail display unit 501. The reason why the frame of a thumbnail 502 is bolded is that the title suggested by the thumbnail 502 is currently selected. Titles to be selected are changed using the direction buttons 122 of the remote controller 121 that is included in the operating input unit 120.

The title list display screen image includes a menu button representation 503. For example, when the menu button 130 of the remote controller 121 is manipulated, the motion picture control unit 101 in turn displays a menu representation 504. The menu representation 504 presents facilities that can be selected through the title list display screen image.

FIG. 5 shows menu items Partial Deletion and M Chapter Designation as examples. However, the present invention is not limited to the menu items. In the menu representation 504, the background of Partial Deletion is changed, that is, Partial Deletion is highlighted. This is intended to signify that the menu item Partial Deletion is currently selected.

The menu items of the menu representation 504 to be selected are switched using the direction buttons of the remote controller 121 (for example, the upward and downward buttons). In FIG. 5, after the title suggested by the thumbnail 502 is selected with a user's manipulation, if the menu item Partial Deletion is selected from the menu representation 504, a transition is made to the partial deletion screen image shown in FIG. 6.

When a transition is made to the partial deletion screen image shown in FIG. 6, the motion picture control unit 101 instructs the motion picture reproduction control unit 108 to reproduce a motion picture having the title suggested by the thumbnail 502. The motion picture control unit 101 then instructs the display screen image production unit 110 to fetch the reproduced motion picture, and displays the motion picture in a motion picture display field 601 defined in the GUI screen image.

Below the motion picture display field 601 included in the GUI screen image, an indicator including a bar-like indicator field is displayed in order to comprehensively present a plurality of chapters, which share a predetermined attribute (the attribute CM or Highlight in the present embodiment) detected during recording of a motion picture having a selected title, in an easy-to-understand manner. The bar indicator 602 includes a cursor representation 603 that points out a currently reproduced position, and indicates a plurality of chapters exhibiting the detected attribute.

The lowermost part of the GUI screen image includes a attribute CM button representation 604 for use in switching attributes of chapters indicated by the indicator 602, and an attribute Highlight button representation 605, and a both-attributes button representation 606 for use in designating both of the attributes CM and Highlight. The button representation of a currently designated attribute is distinguished with a circle filled with, for example, a predetermined color and thus discriminated from the undesignated button representations.

A currently reproduced position time 607 refers to a reproduction time required until a currently reproduced position pointed out by the cursor representation 603 appears, that is, a time that elapses since 0:00:00 when the currently reproduced position is the leading position of motion picture data. Moreover, a current state-of-reproduction indicator 608 that is a mark or characters signifying a current state of reproduction is displayed between the indicator 602 and the button representations 604, 605, and 606 so that the current state of reproduction can be seen at sight. Herein, since reproduction is in progress, a reproduction mark is displayed.

When a transition is made to the screen image shown in FIG. 6 by a user's manipulation, the motion picture control unit 101 displays in the motion picture display field 601 a reproduced picture having the title suggested by the thumbnail 502, and selects the button representation 604, which is associated with the attribute CM, as an initial setting indicating a chapter attribute. At this time, the bar indicator 602 indicates chapters, which are specified in association with the attribute CM in the reproduction control information 112 shown in FIG. 4, by for example, coloring the parts of the bar indicator associated with the positions of the chapters. Thus, the parts associated with the chapters are discriminated from the other part of the bar indicator so that the positions of the chapters exhibiting the selected predetermined attribute can be identified at sight. Herein, since the attribute CM is designated as a chapter attribute, the indicator 602 indicates the chapters, which exhibit the attribute CM (in the example shown in FIG. 4, chapters 4, 8, and 12), by coloring the parts of the indicator associated with the positions the respective chapters.

Thus, chapters of CMs can be identified at sight. Incidentally, coloring is intended to discriminate parts of the indicator, which indicate chapters, from the other part thereof by coloring the frames of the parts or the backgrounds thereof. As long as the parts of the indicator indicating specific chapters can be discriminated from the other part thereof, the present invention is not limited to the coloring. Alternatively, patterning or changing of the shade of a background may be adopted for the discrimination.

When a user depresses the attribute Highlight button 134 of the remote controller 121 so as to select the attribute Highlight button representation 605, a transition is made to the screen image shown in FIG. 7.

The screen image shown in FIG. 7 is nearly identical to the one shown in FIG. 6. However, parts of the bar indicator 602 associated with the positions of chapters whose attributes are specified as Highlight in the reproduction control information 112 shown in FIG. 4 are for example, colored to be thus discriminated from the other part. Thus, the positions of chapters exhibiting a selected predetermined attribute are indicated to be identified at sight.

Herein, since the attribute Highlight is designated as a chapter attribute, the parts of the indicator 602 associated with the positions of chapters exhibiting the attribute Highlight (in the example shown in FIG. 4, chapters CP2, CP6, and CP10) are colored in order to discriminate the parts from the other.

At this time, preferably, the color to be used to distinguish the positions of chapters exhibiting the attribute Highlight should be different from the color to be used to distinguish the positions of chapters exhibiting the attribute CM so that the chapters can be discriminated from the chapters exhibiting the attribute CM.

Moreover, when a user depresses the both-attributes button 135 of the remote controller 121 so as to select the both-attributes button representation 606, a transition is made to the screen image shown in FIG. 8.

The screen image shown in FIG. 8 is nearly identical to the one shown in FIG. 6. However, the parts of the bar indicator 602 associated with the positions of chapters of both CMs and highlights are, for example, colored. Preferably, the color of the parts of the indicator 602 indicating the CMs should be different from the color of the other parts thereof indicating the highlights.

If a user depresses the attribute CM button 133 of the remote controller 121 with the screen image shown in FIG. 7 or FIG. 8 displayed, a transition is, needless to say, made to the screen image shown in FIG. 6.

As mentioned above, according to the present embodiment, a button for use in switching attributes is included. The attributes are switched, and chapters exhibiting a designated attribute are indicated by a bar indicator. Thus, chapters exhibiting a desired attribute can be identified at sight.

For partial deletion, first, chapters exhibiting an attribute that is an object of partial deletion are indicated as mentioned above. A user uses the remote controller 121, which is included in the operating input unit 120, to move the cursor representation 603 while looking at a reproduced picture so as to designate a start point and an end point which define a range of partial deletion. Thus, the range of partial deletion is designated.

The cursor representation 603 is moved by quickly returning or advancing the reproduced picture using the quick return button 128 or quick advance button 129 of the remote controller. While looking at the reproduced picture, the user depresses the decision button 123 when the cursor representation is located at a desired position. Thus, the user can designate the positions of the start and end points.

Preferably, the skip buttons 131 and 132 should be able to be used to jump to the leading position of a chapter, that is, a scene change position. Moreover, if a facility is included for automatically skipping CMs during reproduction, when the operating screen image intended to perform partial deletion is displayed, the automatic skip facility should preferably be inactivated.

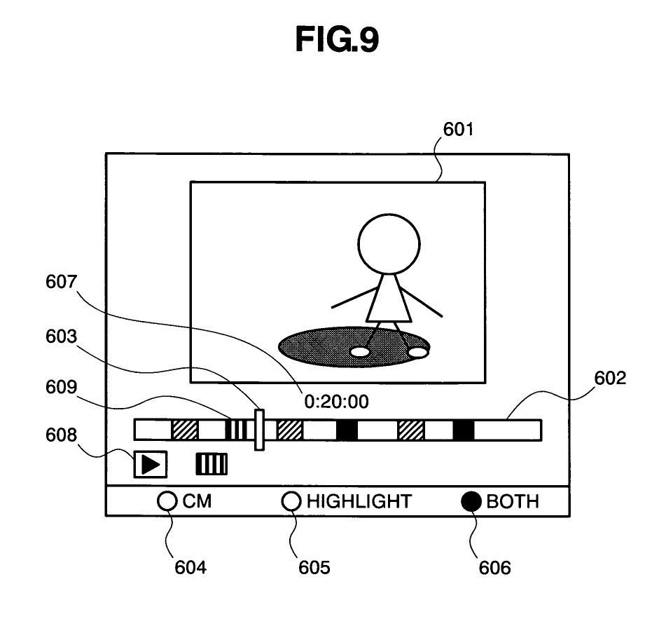

FIG. 9 shows a screen image appearing after partial deletion is designated through the partial deletion screen image shown in FIG. 8 in order to delete chapter CP4 exhibiting the attribute CM.

In FIG. 9, a position selected as an object of partial deletion is, like a deleted part 609, indicated while being colored. The deleted part 609 should preferably be indicated in a color different from the color of the parts of the indicator indicating CMs and the color of the parts thereof indicating highlights.

The position that is an object of partial deletion has been described to be selected by moving the cursor representation 603. The present invention is not limited to this mode. When a button that is included in the operating input unit 120 but is not shown is manipulated, all CM parts or highlight parts may be automatically selected.

In this case, partial deletion can be performed on all chapters exhibiting a specific attribute, for example, all chapters exhibiting the attribute CM. Maneuverability would further improve.

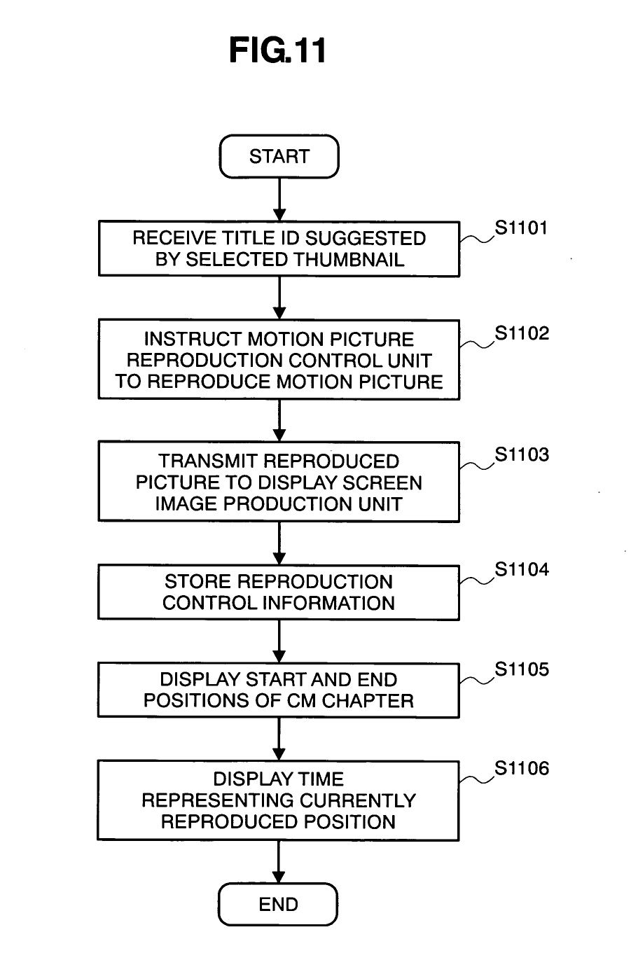

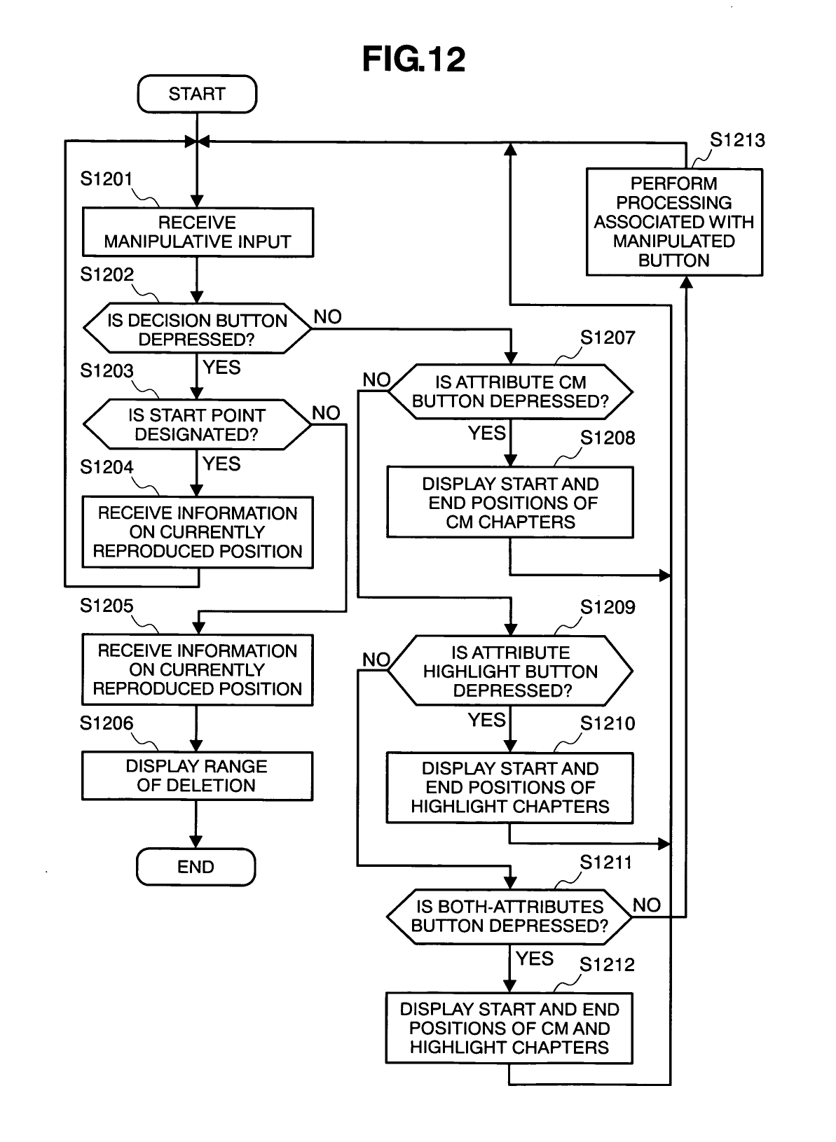

Referring to FIG. 11 and FIG. 12, actions to be performed by the motion picture control unit responsively to the foregoing manipulations will be described below. FIG. 11 is a flowchart describing a procedure started with display of the title list display screen image shown in FIG. 5 and ended with display of the partial deletion operating screen image shown in FIG. 9. FIG. 12 is a flowchart describing a procedure including switching of chapter attributes and execution of partial deletion which are mentioned in conjunction with FIG. 6, FIG. 7, FIG. 8, and FIG. 9. To begin with, a description will be made in conjunction with FIG. 11.

In FIG. 11, upon receipt of a manipulative input that is made at the operating input unit 120 in order to select a thumbnail suggesting a title through the title list display screen image shown in FIG. 5, the motion picture control unit 101 initiates processing. After initiating the processing, the motion picture control unit 101 instructs the data input/output control unit 106 to read management information 201 from the HDD unit 107 at step 1101. The motion picture control unit 101 passes a title ID of a title suggested by the selected thumbnail 502 to the motion picture reproduction control unit 108, and instructs the motion picture-reproduction control unit 108 to reproduce a motion picture having the selected title (step 1102).

The motion picture reproduction control unit 108 instructs the data input/output control unit 106 to read the management information 201 from the HDD unit 107, references the management information 201 so as to read and reproduce motion picture data 111 bearing the title ID passed from the motion picture control unit 101.

The motion picture control unit 101 transmits a picture reproduced by the motion picture reproduction control unit 108 to the display screen image production unit 110 at step 1103. The display screen image production unit 110 in turn displays the motion picture, which is reproduced by the motion picture reproduction control unit 108, in the motion picture display field 601.

Moreover, the motion picture reproduction control unit 108 reads reproduction control information 112 concerning the motion picture data 111, which is being reproduced, from the HDD unit 107, and passes the reproduction control information 112 to the motion picture control unit 101. The motion picture control unit 101 stores the reproduction control information concerning the motion picture data, which bears the selected title ID, in the RAM that is not shown (step 1104). For example, when the button representation 604 shown in FIG. 6 is selected, the motion picture control unit 101 uses the reproduction control information 112 stored in the RAM to transmit the start time instant and end time instant of each of chapters, which are specified to exhibit the attribute CM, to the display screen image production unit 110 (step 1105).

Based on the start time instants and end time instants sent from the motion picture control unit 101, the display screen image production unit 110 colors parts of the indicator 602 associated with the chapters.

At step 1106, the motion picture control unit 101 receives information on a position, which is currently reproduced, from the motion picture reproduction control unit 108, and transmits the information on the position to the display screen image production unit 110. In this case, preferably, the motion picture control unit 101 converts the reproduced position into a time that elapses since 0:00:00 when the leading position is reproduced. The display screen image production unit 110 displays the time equivalent to the received reproduced position as the currently reproduced position time 607.

The motion picture control unit 101 terminates display of the partial deletion operating screen image.

Next, the procedure described in the flowchart of FIG. 12 will be described below. In FIG. 12, the motion picture control unit 101 receives a manipulative input made at the operating input unit 120 at step 1201, and decides at step 1202 whether the decision button 123 is manipulated.

If the motion picture control unit 101 makes a decision in the affirmative (Yes), it proceeds to step 1203. The motion picture control unit 101 decides whether the decision button is manipulated for the first time in order to designate a start point of a range of partial deletion. If a decision is made in the affirmative (Yes) at step 1203, that is, if the decision button is manipulated for the first time in order to designate the start point, information on a position that is currently reproduced is received from the motion picture reproduction control unit 108, and stored in the RAM, which is not shown, as information on the start point position of the range to be deleted. The motion picture control unit 101 then returns to step 1201.

If the motion picture control unit 101 makes a decision in the negative (No) at step 1203, that is, if the decision button is manipulated in order to designate an end point of the range to be deleted, the motion picture control unit 101 proceeds to step 1205. At step 1205, similarly to step 1204, the motion picture control unit 101 receives information on a position, which is currently reproduced, from the motion picture reproduction control unit 108, and stores in the RAM, which is not shown, the reproduced position as information on the end point position of the range to be deleted.

At step 1206, the motion picture control unit 101 transmits the information on the start point position of the range to be deleted and the information on the end point position thereof, which are stored in the RAM that is not shown, to the display screen image production unit 110, and stores them as reproduction control information in the HDD unit 107. Based on the information on the start point position of the range to be deleted and the information on the end point position thereof which are received from the motion picture control unit 101, the display screen image production unit 110 colors parts of the indicator 602 associated with the positions. Thus, processing for partial deletion is terminated.

Consequently, when a motion picture having one title is reproduced, the motion picture is reproduced except parts thereof designated as an object of partial deletion. The parts designated as an object of partial deletion has not been described to be deleted (excluded) but to be preserved. Alternatively, the parts may be deleted.

If the motion picture control unit 101 makes a decision in the negative (No) at step 1202, it proceeds to step 1207, and decides whether the attribute CM button 133 has been manipulated. If the decision is made in the affirmative (Yes) at step 1207, start position time instants and end position time instants of a plurality of chapters exhibiting the attribute CM and information signifying that the button representation 604 has been designated are, for example, as shown in FIG. 6, transmitted to the display screen image production unit 110 on the basis of the reproduction control information stored i-n the RAM, which is not shown, at step 1208. The motions picture control unit 101 instructs the display screen image production unit 110 to paint parts of the indicator 602 associated with the positions in a predetermined color and to fill the circle of the button representation 604 with a predetermined color. The motion picture control unit 101 then returns to step 1201.

If the motion picture control unit 101 makes a decision in the negative (No) at step 1207, it proceeds to step 1209. At step 1209, the motion picture control unit 101 decides whether the attribute Highlight button 134 has been manipulated. If a decision is made in the affirmative (Yes) at step 1209, start position time instants and end position time instants of a plurality of chapters exhibiting the attribute Highlight and information signifying that the button representation 605 has been designated are, for example, as shown in FIG. 7, transmitted to the display screen image production unit 110 on the basis of the reproduction control information stored in the RAM, which is not shown, at step 1210. The motion picture control unit 101 then instructs the display screen image production unit 110 to color parts of the indicator 602 associated with the positions and to fill the circle of the button representation 605 with a predetermined color, and returns to step 1201.

If the motion picture control unit 101 makes a decision in the negative (No) at step 1209, it proceeds to step 1211. At step 1211, the motion picture control unit 101 decides whether the both-attributes button 135 has been manipulated. If a decision is made in the affirmative (Yes) at step 1211, start position time instants and end position time instants of a plurality of chapters exhibiting the attribute CM or attribute Highlight and information signifying that the button representation 606 has been designated are, for example, as shown in FIG. 8, transmitted to the display screen image production unit 110 on the basis of the reproduction control information stored in the RAM, which is not shown, at step 1212. The motion picture control unit 101 instructs the display screen image production unit 110 to color parts of the indicator 602 associated with the positions and to fill the circle of the button representation 606 with a predetermined color, and returns to step 1201.

If a decision is made in the negative (No) at step 1211, the processing associated with a manipulated button is performed at step 1213. For example, assuming that the forward-direction skip button 132 is manipulated, a skip is made to a scene change position succeeding a currently reproduced position. Assuming that the quick advance button 129 is manipulated, reproduction is performed in a quick advance mode. The motion picture control unit 101 then returns to step 1201.

As described above, according to the present embodiment, when a chapter attribute is designated by manipulating the chapter attribute switching buttons including the attribute CM button 133, attribute Highlight button 134, and both-attributes button 135, parts of the indicator 602 indicating chapters that exhibit a designated attribute are colored accordingly. Consequently, whether part of a motion picture currently being reproduced is a commercial message or a highlight scene can be explicitly indicated. This obviates the necessity of feeding frames so as to detect a breakpoint in the motion picture. Eventually, user-friendliness and maneuverability improve.

In FIG. 6 to FIG. 9, the currently reproduced position time 607 refers to a relative time elapsing since 0:00:00 when the leading position of motion picture data is reproduced. Alternatively, the currently reproduced position time 607 may refer to an actual time instant when the currently reproduced position of the motion picture data is recorded.

The attribute button representations have been described to designate the attribute CM or Highlight or both of them. The present invention is not limited to the button representations. For example, the operating input unit may include a button for use in displaying nothing. When the button is selected, any part of the indicator 602 may not be colored at all.

FIG. 6 to FIG. 8 show examples of operating screen images supported by a partial deletion facility so as to introduce an applied example of the present embodiment. The present invention is not limited to the operating screen images. Other facility of switching indications of an indicator may be included.

As described so far, the scene change detection unit detects a change from or into a scene having a specific attribute which is regarded as a border of one chapter. As for the specific attribute, a user may manipulate the operating input unit 120 so as to designate a change from or into a scene exhibiting the attribute.

The menu item M Chapter Designation included in the menu representation 504 shown in FIG. 5 is intended to help a user designate chapters. The menu item M Chapter Designation is associated with a manual chapter designation facility that helps a user designate chapters manually after a motion picture is stored in the HDD unit 107.

For example, assuming that a title suggested by the thumbnail 502 is selected with a user's manipulation through the screen image shown in FIG. 5 and the menu item M Chapter Designation is selected from the menu representation 504, control is passed to an M chapter designation mode. Specifically, a reproduced picture is displayed in the motion picture display field 601 within the screen image, and the cursor representation 603 and manually designated borders of chapters are indicated using the indicator 602. Moreover, the currently reproduced position time of a position indicated by the cursor representation is indicated.

While looking at the reproduced picture, a user manipulates, for example the quick advance button 129 of the remote controller 121 so as to move the cursor representation 603. When the cursor representation indicates a position where a scene change is recognized, the user depresses the decision button 123 so as to designate a border of a chapter. Every time the border of one chapter is designated, it is indicated by the indicator 602. Thus, chapters are manually designated.

Needless to say, a scene change detected by the scene change detection unit may be corrected with a user's manipulation, though it will not be detailed.

### Second Embodiment

According to the first embodiment, when a motion picture is recorded in the HDD unit, the scene change detection unit autonomously detects changes from or into scenes exhibiting a predetermined attribute so that chapters will be delimited. The present invention is not limited to this mode. Depending on an attribute, detection of a scene change may require too much time.

In this case, for example, when a commercial broadcasting program is recorded in real time, application of scene change detection is hard to do. For an attribute making detection of a scene change time-consuming, detection of a scene change should preferably be performed after the completion of picture recording.

The second embodiment that detects a scene change in an automatic chapter designation mode after completion of picture recording will be described below.

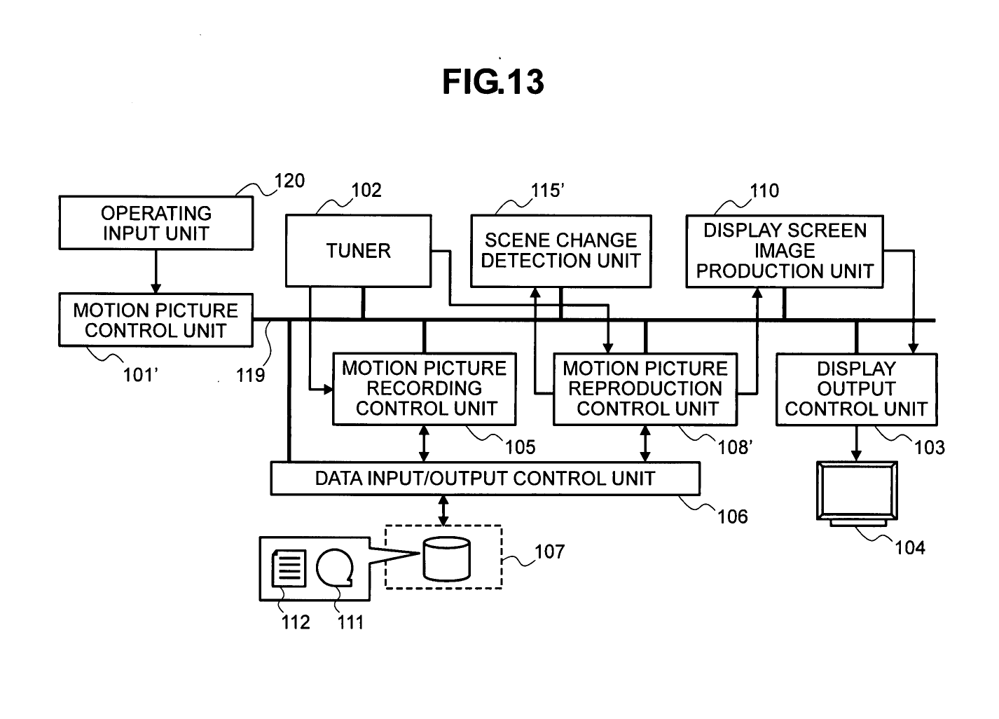

FIG. 13 is a block diagram showing a recording/reproducing apparatus in accordance with the second embodiment. In FIG. 13, the same reference numerals are assigned to components having the same capabilities as those shown in FIG. 1, and an iterative description will be omitted. The recording/reproducing apparatus according to the second embodiment is different from the recording/reproducing apparatus according to the first embodiment only in scene change detecting actions to be performed in the automatic chapter designation mode. The scene change detecting actions to be performed in the automatic chapter designation mode will be mainly described below. Components that act differently from those of the first embodiment during scene change detection will be assigned reference numerals that are accompanied by a superscript.

Referring to FIG. 13, the HDD unit 107 reads a motion picture of a designated title at a high speed, which is different from a normal speed, under the control of a motion picture control unit 101′ so that scene change detection can be achieved for a short period of time.

In an automatic chapter designation mode, a motion picture reproduction control unit 108′ reproduces motion picture data, which is read at a high speed by the HDD unit 107, at a high speed, and transmits the reproduced motion picture to a scene change detection unit 115′. In response to a request issued from the motion picture control unit 101′, the motion picture reproduction control unit 108′ returns information on a currently reproduced position. The other actions are identical to those performed in the first embodiment.

When the motion picture reproduction control unit 108′ reproduces motion picture data, which is recorded in the HDD unit 107, at a high speed, the scene change detection unit 115′ detects a scene change in the motion picture, which is sent from the motion picture reproduction control unit 108′, under the control of the motion picture control unit 101′.

When detecting a scene change, the scene change detection unit 115′ transmits information on the detected scene change and a detected attribute to the motion picture control unit 101′ over the bus 119.

When reproduction is initiated in the automatic chapter designation mode, the motion picture control unit 101′ reads management information that is recorded in the HDD unit 107 during picture recording, and stores reproduction control information associated with a reproduced title ID in the RAM that is not shown. At this time, since scene change detection has not been performed yet, the reproduction control information specifies only one chapter.

Responsively to detection of a scene change performed by the scene change detection unit 115′, the motion picture control unit 101′ queries the motion picture reproduction control unit 108 about information on a currently reproduced position, and regards the information on the currently reproduced position, which is returned from the motion picture reproduction control unit 108′, as information on a scene change position where a scene change occurs. Every time a scene change occurs, information on a scene change position, an attribute, and a chapter number of a new chapter delimited along with the scene change are specified in the reproduction control information, which is stored in advance in the RAM that is not shown, in association with the title ID of the currently reproduced motion picture.

When the scene change detection unit 115′ detects a position where occurrence of a scene change is doubtful, if close analysis is considered to be needed, the motion picture control unit 101′ returns the HDD unit 107 and motion picture reproduction control unit 108′ to the normal reproduction speed. Reproduction may be resumed with a reproduced position set to a little preceding position, and scene change detection may be performed. Needless to say, when scene change detection performed on the position is completed, high-speed reproduction is resumed.

After the high-speed reproduction is completed, the motion picture control unit 101′ transmits as management information the title ID and updated reproduction control information, which are stored in the RAM, to the motion picture recording control unit 105. The motion--picture recording control unit 105 in turn records the managements information in the HDD unit 107.

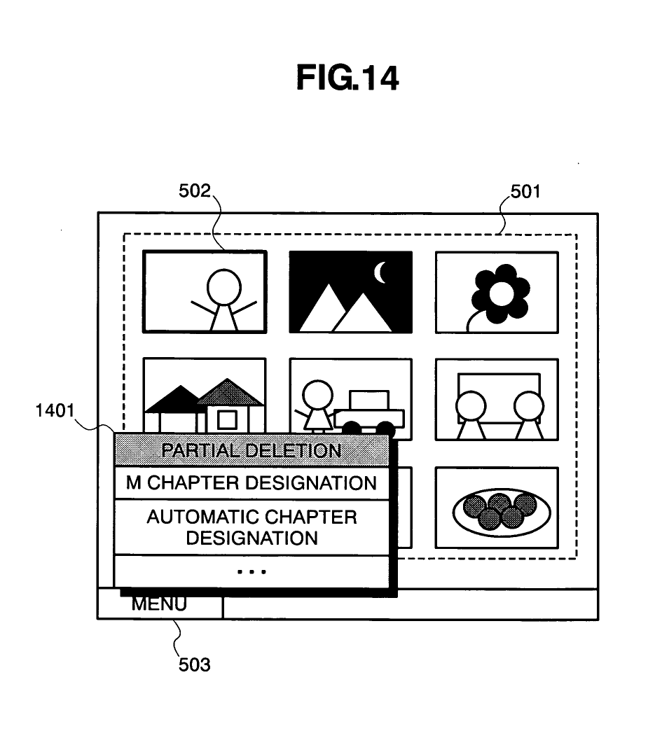

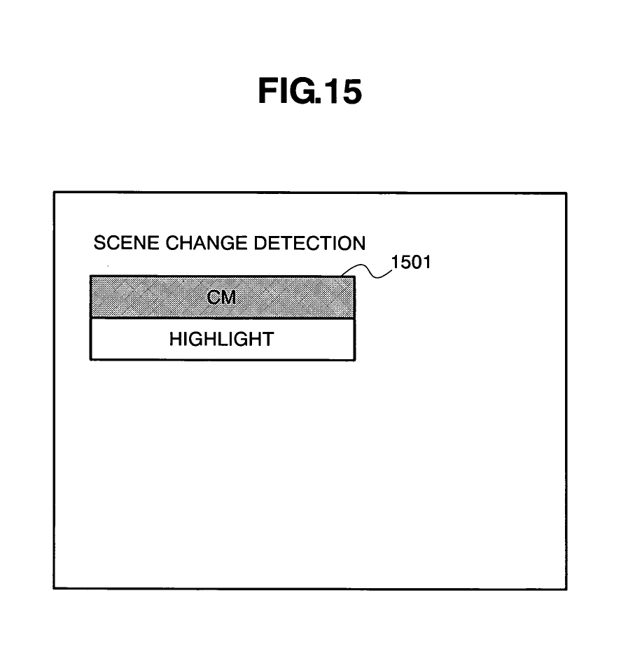

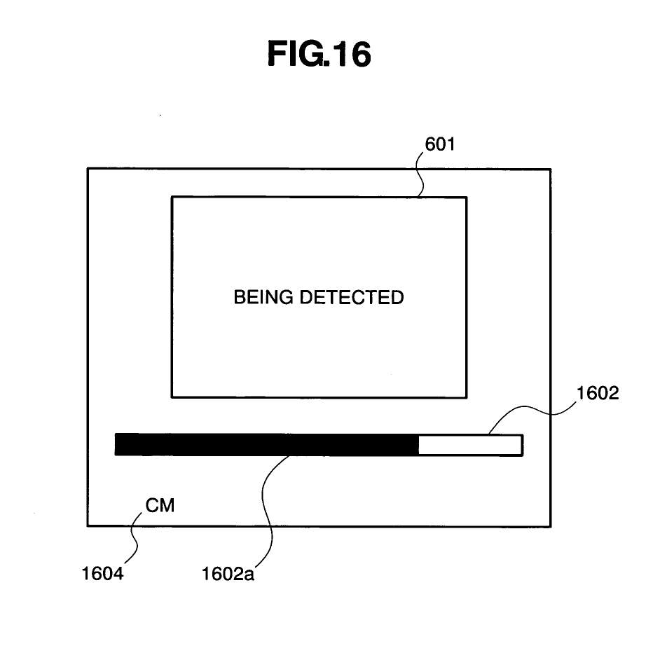

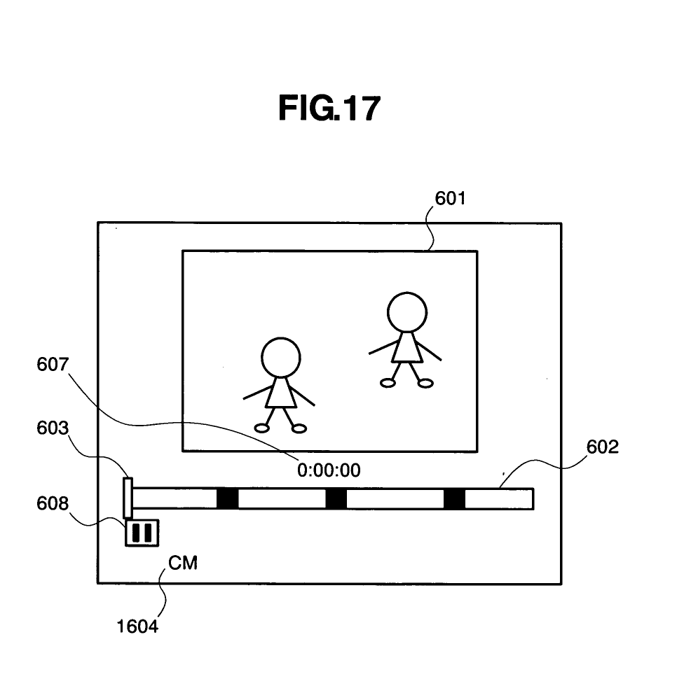

Referring to FIG. 14 to FIG. 17, display screen images displayed by the recording/reproducing apparatus in accordance with the present invention will be described below. FIG. 14 shows a title list display screen image that presents a list of titles of motion picture data items recorded in the HDD unit included in the present embodiment. FIG. 15 shows a menu screen image to be displayed in a case where Automatic Chapter Designation is selected through a scene change detection attribute designation menu display screen image. FIG. 16 and FIG. 17 show a transition from one screen image to another occurring in a case where a change from or into a scene exhibiting the attribute selected through the screen image shown in FIG. 15 is detected. The screen images shown in FIG. 14 to FIG. 17 are produced by the display screen image production unit 110, and displayed on the display device 104 via the display output control unit 103.

FIG. 14 is nearly identical to FIG. 5. A menu item Automatic Chapter Designation is added to the menu representation 1401. In FIG. 14, the same reference numerals are assigned to elements having the same capabilities as those shown in FIG. 5, and an iterative description will be omitted. When the menu item Automatic Chapter. Designation is selected with a user's manipulation from the menu representation 1401 shown in the screen image shown in FIG. 14, a transition is made to a menu screen image permitting selection of a chapter attribute and being shown in FIG. 15.

The screen image shown in FIG. 15 shows a menu representation 1501 permitting designation of an attribute based on which a scene change is detected. The menu items included in the menu representation 1501 refer to attributes (scene change detection attributes) based on which a scene change with which a chapter is delimited is detected. Herein, for example, two attributes Commercial Message (CM) and Highlight are presented. However, the present invention is not limited to these menu items.

Any of the menu items of the menu representation 1501 is selected using, for example, the direction buttons (for example, the upward and downward buttons) of the remote controller 121. If the attribute CM is selected from the menu representation 1501 with a user's manipulation, a transition is made to the screen image shown in FIG. 16.

When a transition is made to the screen image shown in FIG. 16, the motion picture control unit 101′ detects a change from or into a scene exhibiting the attribute (CM), which is selected through the screen image shown in FIG. 15, in the motion picture of the title selected through the screen image shown in FIG. 14.

Specifically, the motion picture control unit 101′ instructs the HDD unit 107 and motion picture reproduction control unit 108′ to reproduce a motion picture of a designated title at a high speed, and instructs the scene change detection unit 115′ to detect a change from or into a scene exhibiting the designated attribute. Consequently, reproduction control information including, for example, as shown in FIG. 4, information on a scene change position, information on a chapter delimited with adjoining scene change positions, and information on the attribute of the chapter is acquired.

In this case, characters “Being detected” are displayed in the motion picture display field 601, and an attribute based on which a scene change is detected is indicated in the lower part of the screen image. Herein, the attribute is the attribute CM 1604.

In the motion picture display field 601, a motion picture that is advanced quickly and that has scene changes detected therein may be displayed on behalf of characters.

Moreover, the progress of scene change detection should preferably be indicated. In FIG. 16, a progress bar 1602 having a colored portion 1602a is used to indicate the progress of scene change detection. A percentage value may be presented instead of the progress bar 1602. When scene change detection is completed, a transition is made to the screen image shown in FIG. 17.

After a transition is made to the screen image shown in FIG. 17, the motion picture control unit 101′ displays in the motion picture display field 601 a motion picture of a specific title, which is paused at the leading position, via the display screen image production unit 110. The cursor representation 603 indicating a currently reproduced position and the currently reproduced position time 607 indicate the leading position of the motion picture. A pause mark is displayed as the current state-of-reproduction representation 608.

At this time, the indicator 602 indicates a plurality of chapters, which exhibit the attribute (CM) selected through the screen image shown in FIG. 15, in the form of colored rectangular parts. Accordingly, the attribute CM 1604 is presented in the lower part of the screen image. Consequently, a user can recognize the delimited chapters of CMs at sight.

Likewise, the attribute Highlight may be selected, and scene change detection may be performed based on the attribute Highlight. Consequently, reproduction control information like the one shown in FIG. 4 can be produced.

Similarly to the first embodiment, the second embodiment includes the buttons for use in switching chapter attributes. Consequently, thereafter, the chapter attributes are switched and chapters exhibiting a designated attribute are indicated using the bar indicator. A user can identify at sight chapters exhibiting his/her desired attribute, and will find the second embodiment user-friendly.

As mentioned above, according to the present embodiment, after picture recording is completed, scene change detection is performed. Consequently, chapters can be highly precisely delimited based on an attribute.

In the first embodiment, when picture recording is performed, scene change detection is performed. In the second embodiment, after picture recording is completed, scene change detection is performed. The present invention is not limited to these modes. As for an attribute (for example, attribute CM) permitting quick detection of changes from or into scenes which exhibit the attribute, scene change detection may be performed during picture recording. As for an attribute (for example, the attribute Highlight) making detection of changes from or into scenes, which exhibit the attribute, time-consuming, scene change detection may be performed after completion of picture recording. Namely, depending on an attribute, scene change detection may be performed during picture recording or after completion of the picture recording.

The foregoing idea is readily feasible by combining the first and second embodiments. A further description will be omitted.

What is claimed is:

1. A recording/reproducing apparatus comprising:
a program recording unit that records program data;
a sampling unit that samples chapter data items, which exhibit different attributes, from the program data recorded by the program recording unit;
a display unit that displays an indicator field that signifies to which temporal positions in the recorded program data the plurality of chapter data items sampled by the sampling unit correspond;
an attribute selection unit that selects a desired attribute from among the plurality of attributes; and
a control unit that, when the indicator:field is displayed on the display unit, extends control so that to which temporal positions in the recorded program data the chapter data items exhibiting the attribute selected by the attribute selection unit correspond will be indicated using the indicator field.

2. The recording/reproducing apparatus according to claim 1, wherein:
the plurality of attributes includes at least information on CMs and information on highlights; and
the control unit extends control so that the sampling unit will sample CM scenes or highlight scenes, which are included in the program data, according to a predetermined criterion.

3. The recording/reproducing apparatus according to claim 2, wherein when the sampling unit samples the highlight scenes, the control unit extends control so that the sampling unit will sample each highlight scene on the basis of a change from or into a scene occurring in the program data or a change in audio data occurring therein.

4. The recording/reproducing apparatus according to claim 1, wherein the control unit extends control so that a screen image supported by the attribute selection unit and permitting selection of a desired attribute from among the plurality of attributes will be displayed on the display unit.

5. The recording/reproducing apparatus according to claim 1, wherein when the program data is recorded in the recording unit, the control unit extends control so that the sampling unit will sample chapter data items.

6. The recording/reproducing apparatus according to claim 1, further comprising a receiving means for receiving the attributes together with the program data.

7. The recording/reproducing apparatus according to claim 1, wherein when the indicator field is displayed on the display unit, the control unit extends control so that: the indication signifying to which temporal positions in the recorded program data the chapter data items exhibiting the attribute selected by the attribute selection unit correspond will be designated or the indication signifying to which temporal positions in the recorded program data the chapter data items exhibiting all the different attributes correspond will be designated; and the indication of the indicator field will be varied depending on the designation.

8. The recording/reproducing apparatus according to claim 1, wherein the control unit extends control so that the indication signifying to which temporal positions in the recorded program data the chapter data items exhibiting the attribute designated by the attribute selection unit correspond will be highlighted to be discriminated from the other indication of the indicator field.

9. A recording/reproducing apparatus comprising:
an input unit that receives video information including data items which exhibit different attributes;
a recording unit that records the video information sent from the input unit;
an attribute detection unit that detects the plurality of attributes in the video information;
a reproduction unit that reproduces the video information recorded in the recording unit; and
a control unit that, when the reproduction unit reproduces the video information, extends control so that an indicator field which indicates the progress of the reproduction of the video information and an indicator field which permits selection of any of the plurality of attributes will be shown in the same screen image.

10. The recording/reproducing apparatus according to claim 9, further comprising a video-fields delimiting unit that divides the video information into a plurality of fields using the plurality of attributes detected by the attribute detection unit, wherein:
the control unit allows the video-fields delimiting unit to use one attribute selected through an indicators field that permits selection of the plurality of attributes; and
the control unit extends control so that part of the indicator field, which indicates the progress of the reproduction of the video information, associated with a reproduced position in the divided video information will be highlighted.

11. The recording/reproducing apparatus according to claim 10, wherein for highlighting, the control unit differentiates the color or shape of the part of the indicator field, which indicates the progress of the production of the video information, associated with the reproduced position in the divided video information from the color or shape of the other part of the indicator field.
